(19) United States
(12) Patent Application Publication
(10) Pub. No.: US 2007/0075024 A1
(43) Pub. Date: Apr. 5, 2007

(54) Advanced gravity sedimentation system and method

(76) Inventors: Brian W. Campbell, New Plymouth (NZ); Simon D. Seaton, The Woodlands, TX (US)

Correspondence Address: JOHN W. WUSTENBERG, P.O. BOX 1431, DUNCAN, OK, 73536, US

(21) Appl. No.: 11/243,173

(22) Filed: Oct. 4, 2005

(51) Int. Cl. B01D 21/02

(52) U.S. Cl. 210/802; 210/521; 210/524

(57) ABSTRACT

In one embodiment, a sedimentation-control system is provided, comprising a housing and an inlet in the housing, through which fluid may flow into the housing. This embodiment also comprises an outlet, through which fluid may flow out of the housing and a plurality of inclined plates in the housing. This embodiment also comprises a collection auger near the bottom of the housing, wherein the collection auger may transport material that drops out of fluid within the housing, and a drying auger, wherein the drying auger couples to the housing near a terminus of the collection auger, and wherein the drying auger transports material collected by the collection auger away from the housing.

### BACKGROUND

The present invention relates to drilling and production of oil and gas wells, and more particularly, to novel systems and methods for removing solids from fluids used in the drilling and production of oil and gas wells.

In drilling an oil or gas well, cuttings and other debris must be continually removed from the well. Otherwise, this debris may collect under the drill bit and impede further drilling. One conventional method to shuttle this debris away from the drill bit and to the surface is to circulate a viscous drilling fluid down through the bit and up through the well bore. Typically, this viscous drilling fluid will be designed to carry or suspend debris, often using one or more solids-suspension agents. Conventional sedimentation-control equipment used in the oilfield industry, therefore, often is designed to remove drilling debris that is suspended in a viscous drilling fluid. Once the debris is removed, the cleaned drilling fluid may be recycled to the well bore or sent to a storage facility.

For some wells, however, viscous drilling fluids are not an option. To drill wells in an underbalanced condition, for example, lighter-weight drilling fluids must be used, such as crude oil, refined oil or gaseated fluids. These fluids typically have little to no carrying capacity for debris unless a solids-suspension agent has been added. Therefore, as soon as fluid velocities decrease, as may occur after the drilling fluid arrives at the surface, any suspended material will drop out of the drilling fluid. This material will collect at the bottom of any vessel storing or processing the fluid. Rapid sedimentation in sedimentation-control equipment and storage tanks can plug flow lines and prevent pumps from drawing material from tanks during processing. As a result, the fluid may not even reach sedimentation-control equipment before any entrained material settles and packs. Some underbalanced drilling systems rely on a series of sedimentation tanks to clean drilling fluid. The sedimentation tanks may need to be vacuumed or otherwise manually cleaned to remove collected material, which increases operator exposure and costs. Moreover, when formation fluids are produced along with the drilling fluid at the surface, conventional sedimentation-control equipment must be enclosed and vented to a flare, nitrogen purged, or positioned outside of any hazardous areas to avoid producing unsafe conditions for system operators.

### SUMMARY

The present invention relates to drilling and production of oil and gas wells, and more particularly, to novel systems and methods for removing solids from fluids used in the drilling and production of oil and gas wells.

One embodiment of the present invention is a sedimentation-control system comprising a housing and an inlet in the housing, through which fluid may flow into the housing. This embodiment also includes an outlet, through which fluid may flow out of the housing and a plurality of inclined plates in the housing. This embodiment also includes a collection auger near the bottom of the housing, wherein the collection auger may transport material that drops out of fluid within the housing, and a drying auger, wherein the drying auger couples to the housing near a terminus of the collection auger, and wherein the drying auger transports material collected by the collection auger away from the housing.

Another embodiment of the present invention is a sedimentation-control system comprising a housing and an inlet in the housing, through which fluid may flow into the housing. This embodiment also includes an outlet, through which fluid may flow out of the housing. This embodiment also includes a plurality of inclined plates in the housing and a band of water within the housing. This embodiment also includes a collection auger near the bottom of the housing, wherein the collection auger may transport material that drops out of fluid within the housing, and a drying auger, wherein the drying auger couples to the housing near a terminus of the collection auger, and wherein the drying auger transports material collected by the collection auger away from the housing.

Another embodiment of the present invention is a method for removing suspended material from drilling fluid, comprising the steps of passing drilling fluid containing suspended material over a plurality of inclined plates; collecting any material that drops out of the drilling fluid in a trough located below the plurality of inclined plates; and transporting the collected material through the trough using a collection auger. This embodiment also includes the steps of removing the collected material from the trough using a drying auger; drying collected material in the drying auger; and collecting the drilling fluid from which solids have been removed.

The features and advantages of the present invention will be readily apparent to those skilled in the art. While numerous changes may be made by those skilled in the art, such changes are within the spirit of the invention.

### BRIEF DESCRIPTION OF THE DRAWINGS

The present invention may be better understood by reading the following description of non-limiting embodiments with referenced to the attached drawings, wherein like parts of each of the several figures are identified by the same reference characters. The drawings are briefly described as follows:

FIG. 1 illustrates an example sedimentation-control system, with part of a housing removed to show the contents of the example sedimentation-control system;

FIG. 2 is a cross-sectional view of an example sedimentation-control system, with part of the housing removed to show the contents of the example sedimentation-control system; and

FIG. 3 schematically illustrates fluid flow within an example sedimentation-control system; and

FIG. 4 illustrates an example sedimentation-control system, with part of a housing removed to show the contents of the example sedimentation-control system.

These drawings illustrate certain aspects of some of the embodiments of the present invention and therefore should not be used to limit or define the invention, as the invention encompasses equally effective additional or equivalent embodiments.

### DESCRIPTION OF PREFERRED EMBODIMENTS

The present invention relates to drilling and production of oil and gas wells, and more particularly, to novel systems and methods for removing solids from fluids used in the drilling and production of oil and gas wells. Systems and methods embodying the present invention provide a series of inclined plates to capture solids as they fall out of the drilling fluid. Such systems and method embodying the present invention may be used with non-suspending drilling fluids and may even capitalize upon the low carrying capacity of non-suspending drilling fluids by accelerating the natural sedimentation process while preventing material from re-entering the fluid phase. One advantage of embodiments of the present invention over conventional sedimentation-control equipment and methods used by the oilfield services industry is that certain embodiments of the present invention may be used in hazardous zones and may not require vacuuming or other manual cleaning methods to remove settled solids. Further, systems and methods embodying the present invention may have an additional advantage of concentrating deposited material into a sludge having a greater percentage of solids per volume over sludges produced by conventional systems and methods.

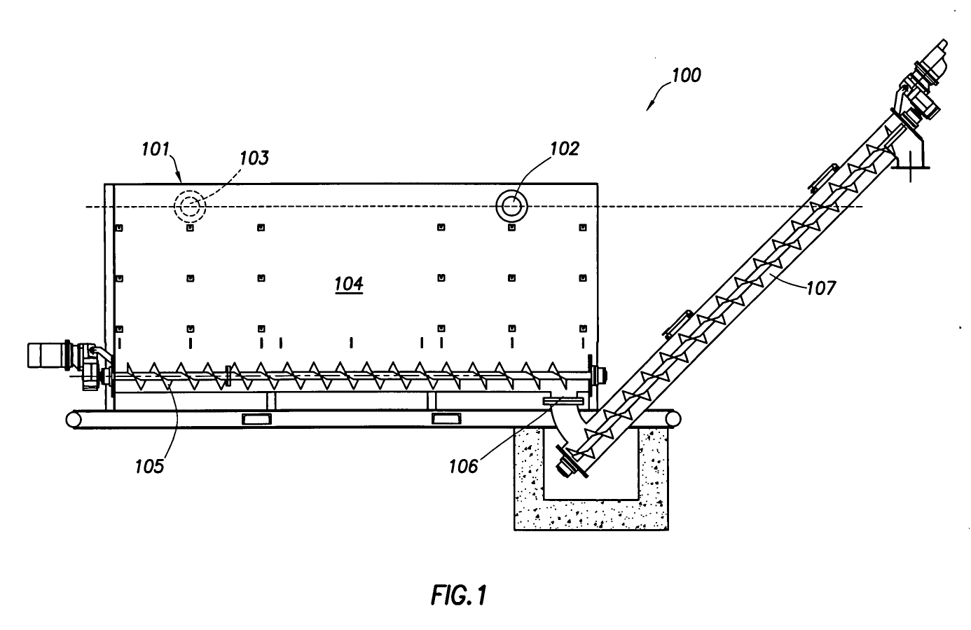

FIG. 1 illustrates a view of one embodiment of a sedimentation-control system according to the present invention, denoted generally by the numeral 100. Sedimentation-control system 100 includes a housing 101. In some embodiments of sedimentation-control system 100, housing 101 will be the size of a standard-sized container typically used on container ships, railroad cars, or trucks to help ease transportation of the system to job sites. For example, some embodiments may be the size of a 40-foot-by-8.5-foot standardized container used on container ships. Part of housing 101 has been removed to show the contents of sedimentation-control system 100. Housing 101 may include an inlet 102 and an outlet 103. Fluid to be cleaned may enter sedimentation-control system 100 through inlet 102 and exit through outlet 103. Outlet 103 is depicted on the opposite side of housing 101 from inlet 102, but it may be located on the same or another side, as necessary. However, it may be preferable for the height of outlet 103 from the bottom of housing 101 to be substantially the same as the height of inlet 102 from the bottom of housing 101. Housing 101 includes a cavity 104, through which fluid may travel en route to outlet 103. A series of plates, not shown in FIG. 1, are present in cavity 104, as discussed in greater detail later in this disclosure.

A collection auger 105 rests horizontally near the bottom of housing 101. Material that collects at the bottom of housing 101 may be drawn out of cavity 104 using collection auger 105. This material will travel along collection auger 105 towards the end of housing 101 closest to inlet 102, which is at the right of the example housing 101 shown in FIG. 1. This material will then pass through port 106 into drying auger 107. Drying auger 107 may elevate the material above the equilibrium level of fluid in housing 101 and drying auger 107, as indicated by the dotted line in FIG. 1. Once the material is elevated above this level, it will begin drying, as it will no longer be exposed to the fluid. Drying auger 107 may continue to raise the material above housing 101 and deposit it elsewhere, such as into an open-top skip, other vessel, or, perhaps, a different solid-treatment mechanism. Collection auger 105 and drying auger 107 may be powered by a power system not depicted in FIG. 1.

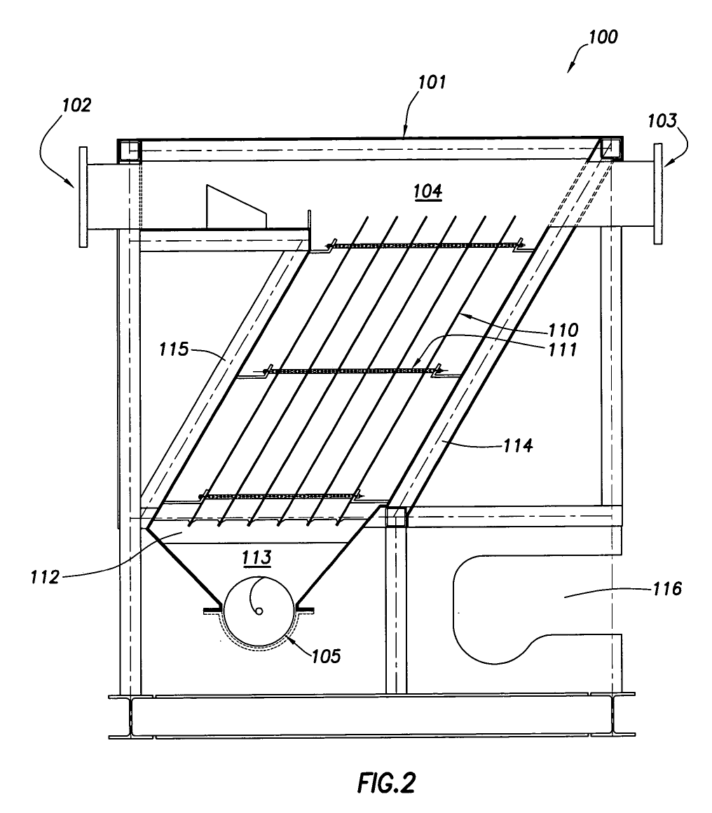

As fluid travels through cavity 104 from inlet 102 to outlet 103, it passes a series of plates. FIG. 2 shows a cross-section of housing 101 that illustrates some example plates 110. As shown in FIG. 2, in some embodiments, the top and bottom edges of the example plates 110 are parallel with the top and bottom of housing 101. In particular, the top edge of each plate 110 may be roughly aligned with the direction of fluid flow as the fluid travels from inlet 102 to outlet 103. This positioning may help plates 110 take advantage of laminar flow of the fluid within cavity 104. Plates 110 may incline toward the side of housing 101 where inlet 102 is located. The incline of plates 110 helps ensure that as fluids pass over plates 110, material that drops out of the fluids slides down along the plates to the bottom of housing 101 and does not re-enter the fluid. Each plate 110 may substantially parallel with one or more neighboring plates, as shown in FIG. 2.

To help facilitate the solids' journal to the bottom of housing 101, plates 110 may be constructed such that they have low-friction surfaces. Plates 110, however, may be any material that can be adapted to have low-friction surfaces, so long as that material can withstand long periods of contact with drilling or formation fluids and any other fluids, gases, or solids that may be mixed with or suspended in those fluids. For example, plates 110 might be made of steel that has been painted or coated with a friction-reducing coating, uncoated steel (so long as the surfaces of plates 110 are relatively smooth), or other suitable friction-reducing material, which may also include synthetic materials. Each plate 110 may span the length of housing 101. Alternatively, several groups of plates 110 may be placed serially through the length of housing 101. Supports 111 and 112 may be provided to prop and anchor plates 110 inside cavity 104 of housing 101. A trough 113 with sloping walls may be provided to help channel solid material to collection auger 105. Further, housing 101 may incorporate internal walls 114 and 115 that are parallel to the large surfaces of plates 110. A cavity 116 may also be provided to store drying auger 107 when sedimentation-control system 100 is not in use.

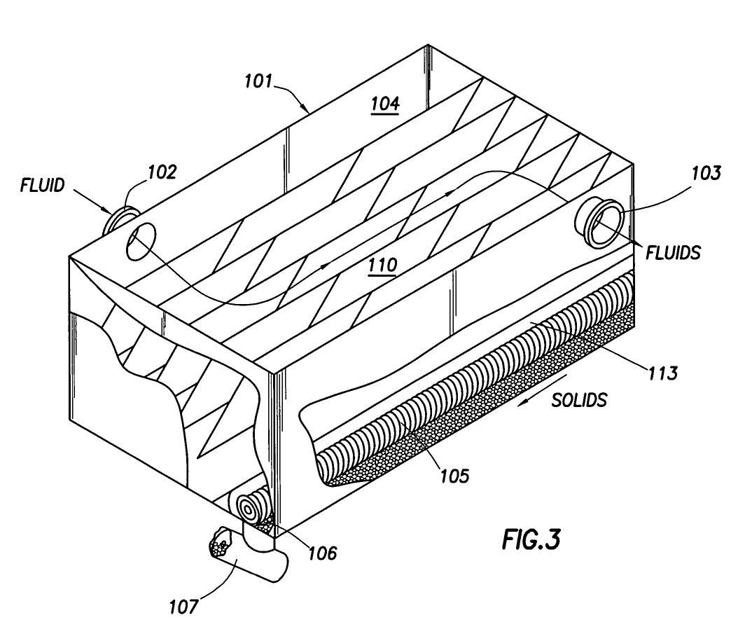

FIG. 3 illustrates schematically the movement of fluid in an example sedimentation-control system 100. Housing 101 is depicted as transparent so that the contents of the system and the imagined fluid flow may be seen. A fluid containing suspended material may pass through inlet 102 at a relatively high velocity and enter cavity 104 in housing 101. The fluid may then pass over inclined plates 110, gradually slowing in the process. As the fluid slows, the suspended material drops out of the fluid and pass over plates 110. Eventually, this material will collect in trough 113, where it will be scooped up by collection auger 1O5. Collection auger 105 then transports the material to port 106. The material passes through port 106 and is raised by drying auger 107 (shown only in part in FIG. 3). Drying auger 107 will then raise the material to an elevation above the equalized fluid level in housing 101 and drying auger 107 to facilitate drying. Drying auger 107 may then discharge the material wherever the operator desires, such as into a treatment mechanism or collection vessel (not shown in FIG. 3). In the meantime, the fluid will exit housing 101 through outlet 103.

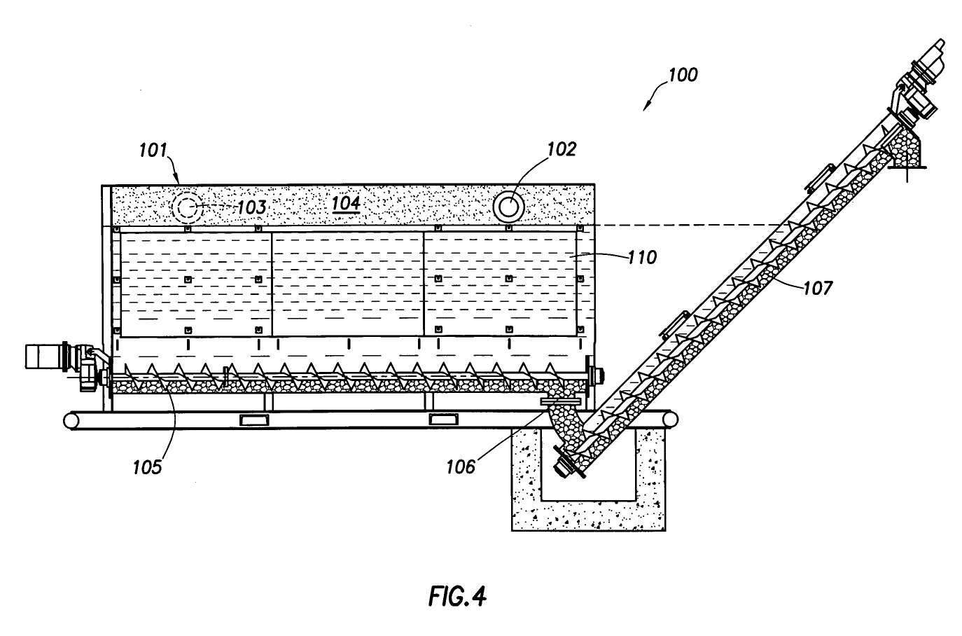

Certain embodiments of sedimentation-control system 100 may incorporate a water phase to help separate and clean the collected materials. These embodiments may be particularly useful when the drilling fluid contains oil or gases, such as in an underbalanced drilling system using crude oil, refined oil, an oil/gas mixture, or some other fluid containing hydrocarbons. FIG. 4 illustrates an embodiment of sedimentation-control system 100 incorporating a water phase. Three bands of materials fill cavity 104: a top band of drilling fluid (indicated by the dotted area in FIG. 4), a middle band of water (indicated by the striped area in FIG. 4), and a lower band of deposited solid materials (shown by the pebble pattern in FIG. 4). The water for the water phase may be supplied through a water inlet, not shown in FIG. 3. Again, fluid containing oil, gas or other hydrocarbons may pass through inlet 102 into chamber 104. The fluid will naturally float across the top of the water phase. Suspended material, however, may drop out of the fluid and pass down along plates 110 to trough 113, as described above. In the process of passing through the water phase, however, any hydrocarbon residue on the formerly suspended material may be removed. To facilitate this cleaning process, the water for the water phase may be heated by a water-heating system inside sedimentation-control system 100 (not shown in FIG. 4). A surfactant, detergent, or demulsifier may be added to the water to aid in cleaning. As the material passes over plates 110 and collects in trough 113, collection auger 105 will transport the material along the bottom of housing 101. Once the material passes through port 106, it will be transported upwards by drying auger 107. Water will enter drying auger 107 along with the material, but, again, water will be present in drying auger 107 only up to the equilibrium height of the water phase in housing 101, as demonstrated by the dashed line in FIG. 4. The collected material, however, will continue up through the entire length of drying auger 107 and begin drying after it passes the water level. Meanwhile, the drilling fluid, now with a reduced solids content, will exit housing 101 through outlet 103.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. The particular illustrative embodiments disclosed above may be altered or modified. All such variations are considered within the scope and spirit of the present invention. The terms in the claims have their plain, ordinary meaning unless otherwise explicitly and clearly defined by the patentee.

What is claimed is:

1. A sedimentation-control system, comprising:
a housing,
an inlet in the housing, through which fluid may flow into the housing,
an outlet, through which fluid may flow out of the housing,
a plurality of inclined plates in the housing,
a collection auger near the bottom of the housing, wherein the collection auger may transport material that drops out of fluid within the housing, and
a drying auger, wherein the drying auger couples to the housing near a terminus of the collection auger, and wherein the drying auger transports material collected by the collection auger away from the housing.

2. The sedimentation-control system of claim 1, wherein each inclined plate has a top edge and a bottom edge that are substantially aligned with fluid flow in the housing from the inlet to the outlet, and wherein each inclined plate is inclined toward the outlet.

3. The sedimentation-control system of claim 1, further comprising a trough located below the plurality of inclined plates and surrounding the collection auger.

4. The sedimentation-control system of claim 1, wherein the housing is substantially the same size as a standard shipping container.

5. The sedimentation-control system of claim 1, wherein the inlet and the outlet are located at a substantially equivalent height in the housing.

6. The sedimentation-control system of claim 1, wherein the plurality of inclined plates is formed of friction-reducing material.

7. The sedimentation-control system of claim 1, further comprising a storage passage within the housing for the drying auger.

8. A sedimentation-control system, comprising:
a housing,
an inlet in the housing, through which fluid may flow into the housing,
an outlet, through which fluid may flow out of the housing,
a plurality of inclined plates in the housing,
a band of water within the housing,
a collection auger near the bottom of the housing, wherein the collection auger may transport material that drops out of fluid within the housing, and
a drying auger, wherein the drying auger couples to the housing near a terminus of the collection auger, and wherein the drying auger transports material collected by the collection auger away from the housing.

9. The solids control system of claim 8, wherein each inclined plate has a top edge and a bottom edge that are substantially aligned with fluid flow in the housing from the inlet to the outlet, and wherein each inclined plate is inclined toward the outlet.

10. The sedimentation-control system of claim 8, further comprising an additive mixed in the band of water, wherein the additive is selected from the following group: a surfactant, a detergent, and a demulsifier.

11. The sedimentation-control system of claim 8, further comprising a water-heating system within the housing, wherein the water-heating system supplies heat to the band of water.

12. The sedimentation-control system of claim 8, wherein water from the band of water may enter the drying auger and rise within the drying auger until it reaches a height that is substantially even with an equilibrium level of the band of water.

13. The sedimentation-control system of claim 8, further comprising a trough located below the plurality of inclined plates and surrounding the collection auger.

14. The sedimentation-control system of claim 8, wherein the housing is substantially the same size as a standard shipping container.

15. The sedimentation-control system of claim 8, further comprising a storage passage within the housing for the drying auger.

16. A method for removing suspended material from drilling fluid, comprising the steps of:
passing drilling fluid containing suspended material over a plurality of inclined plates,
collecting any material that drops out of the drilling fluid in a trough located below the plurality of inclined plates;
transporting the collected material through the trough using a collection auger;
removing the collected material from the trough using a drying auger
drying collected material in the drying auger; and
collecting the drilling fluid from which solids have been removed.

17. The method for removing suspended material from drilling fluid of claim 16, wherein the step of passing drilling fluid containing suspended material over a plurality of inclined plates comprises the step of passing drilling fluid containing suspended material over a plurality of inclined plates arranged such that material dropping out of the drilling fluid are substantially prevented from re-entering the drilling fluid, wherein the plurality of inclined plates is formed of a friction-reducing material.

18. The method for removing suspended material from drilling fluid of claim 16, further comprising the step of bathing any material that drops out of the drilling fluid in water as it falls into the trough.

19. The method for removing suspended material from drilling fluid of claim 16, further comprising the step of bathing any material that drops out of the drilling fluid in heated water as it falls into the trough.

20. The method for removing suspended material from drilling fluid of claim 16, further comprising the step of bathing any material that drops out of the drilling fluid in a solution as it falls into the trough, wherein the solution comprises water and an additive selected from the following group: a detergent, a surfactant, and a demulsifier.
